(19) United States
(12) Patent Application Publication
(10) Pub. No.: US 2003/0084684 A1
(43) Pub. Date: May 8, 2003

(54) Method of reducing a hydrogen content of an optical fiber or preform

(75) Inventor: Ying Hua Zhang, Sharon, MA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS UNIPHASE CORPORATION, SAN JOSE, CA

(21) Appl. No.: 10/278,741

(22) Filed: Oct. 21, 2002

Related U.S. Application Data
(60) Provisional application No. 60/345,135, filed on Oct. 19, 2001.

(51) Int. Cl. C03B 37/018

(52) U.S. Cl. 65/391

(57) ABSTRACT

The invention provides a method of passivating an optical fiber or preform by reducing a hydrogen content in the fiber or preform using a deuterium ion plasma passivation process or a high temperature deuterium gas passivation of preforms for exchanging at least a portion of the hydrogen contained within the optical fiber or preform with deuterium. The deuterium plasma is generated from a deuterium gas. To further reduce the passivation, the optical fiber or preform are heated in the deuterium plasma. If desired, the deuterium plasma is applied to an inner wall of a preform tube before collapsing the preform tube into a preform rod.

### CROSS-REFERENCE TO RELATED APPLICATIONS

This applications claims priority of U.S. Provisional Patent Application No. 60/345,135 file don Oct. 19, 2001, entitled “Deuterium Plasma and High Temperature Methods for Passivating Er Doped Fiber or Preform” which is incorporated herein by reference for all purposes.

### MICROFICHE APPENDIX

Not Applicable

### FIELD OF THE INVENTION

The present invention generally relates to the field of optical fibers and preforms and in particular to a method of reducing a hydrogen content of an optical fiber or preform.

### BACKGROUND OF THE INVENTION

The manufacture of optical waveguide fibers has long passed from an early, primarily experimental stage to a fully commercial stage in which a growing number of customers' transmission needs are being satisfied over short and long distances and at various wavelengths. The manufacture of commercial fiber typically is based on silica glass technology and involves drawing from a massive body or preform having a cross-sectional refractive index profile as designed for effective guiding of one or several radiation modes.

With respect to most currently used optical fiber, optical waveguide structure can be described in terms of a higher-index core portion which is surrounded by a lower-index cladding portion. At the core-cladding interface there may be a relatively abrupt change in refractive index; alternatively, and especially in the case of fibers designed for the transmission of a plurality of modes, refractive index may decrease gradually towards a fiber surface. A refractive index difference between core and cladding typically results from the addition of one or several suitably chosen dopants or additives to otherwise essentially pure silica; e.g., the addition of boron or fluorine results in a lowered (cladding) refractive index, and the addition of aluminum, germanium phosphorus, or titanium produces an increased (core) refractive index.

As of late, there has been an increased interest in hydrogen induced losses in optical fibers. This is attributed to hydrogen reactions occurring at germanium-related defect sites created during the addition of germanium as a dopant; A. Tomita & P. J. Lemaire, Electronics Letters, 17^{th} January 1985, Vol. 21, No. 2, pp. 71-72. Lemaire et al. disclosed in OFC/IOOC '93 Technical Digest TuL3 that such hydrogen induced losses do not usually constitute a problem for single mode fibers, however, they are of potential concern for highly doped fibers used in erbium doped fiber amplifiers (EDFA). AT&T Bell Laboratories first discovered that erbium doped fiber is susceptible to long-term degradation caused by hydrogen induced loss increases in installed optical fibers. In 1993, Lemaire et al. (OFC/IOOC '93 Technical Digest TuL3) confirmed that typical erbium doped fiber compositions were highly reactive when exposed to even low levels of ambient hydrogen. Erbium-doped fibers made by different manufacturers using different processing techniques showed that this high reactivity is inherent in the most widely used erbium-doped fiber compositions based on GeO₂.Al₂O₃ co-doped host. This potential reliability problem is recognized and addressed in Telcordia requirements. For example, Telcordia specification (Bellcore GR-1312-Core, Issue 3, April 1999) per Section 8.1.3 of GR-1312-core requires the demonstration of 20 years of product life at 0.01 atm of hydrogen at 38° C. Therefore, reducing hydrogen aging is important for erbium-doped fibers and their use in EDFAs.

Erbium is of very special interest because it can provide gain in the low loss window of long haul transmission fiber. Due to the nature of the erbium atom, the gain provided in this window is not flat, rather, it has a particular gain shape which is undesirable. In order to achieve gain flatness, gain-flattening filters are used successfully. One environmental concern for amplifiers that use erbium doped fiber is exposure to hydrogen. Hydrogen can diffuse into the fiber core region where it can react with germanium and silicon defect centers to form OH groups, which cause optical loss in the wavelength region of interest. For erbium doped fiber, this effect can cause the gain shape of the fiber to change and render the gain flattening filter useless for the application.

The state of the art discloses several approaches to reduce hydrogen aging problems. Hermetic fiber coating and deuterium passivation are two of the most widely accepted methods for reducing such hydrogen induced losses.

P. J. Lemaire et al. (Optical Engineering, Vol. 30, No. 6,780, 1991) disclose that carbon coating on the fiber can be used as a barrier to dramatically slow down the hydrogen penetrating to the fiber core and hence prevent loss increases. The carbon coaxing is applied using an on-line CVD reaction during the fiber drawing process. Even though this method offers a viable method to reduce hydrogen aging, it requires extra processing steps, such as cleaving, splicing, and re-coating of such hermetically sealed fiber, and hence requires additional quality control procedures.

A more recent approach in reducing hydrogen aging or hydrogen induced loss increases is carried out using the method of deuterium passivation. Hydrogen induced losses are associated with both, dissolved molecular hydrogen H₂ and species, such as hydroxyl OH which form when hydrogen H₂ reacts with the fiber core. For example, when erbium-doped fibers are exposed to hydrogen H₂ or deuterium D₂, hydroxyl or deuteroxyl species are formed in the core of an optical fiber, particularly in a germanium-doped core, and an isotope exchange of hydroxyl and deuteroxyl, OH⇄OD, can occur. Therefore, if an optical fiber is treated with deuterium, the deuteroxyl species will replace the hydroxyl species. Accordingly, the OH absorption band at 1.42 μm is shifted to a 1.95 μm OD absorption band which is substantially away from the working wavelength of an erbium-doped fiber amplifier (EDFA). Hence, hydrogen aging or hydrogen-induced loss increases are reduced.

However, the present deuterium passivation process is to treat polymer coated erbium-doped fibers in a high pressure deuterium gas at a certain temperature which is limited by the temperature stability of the polymer coating. Usually, polymer coated fibers can only be heated up to 200° C. as the polymer starts to decompose if the fiber is heated above this temperature. As a result, it takes weeks to perform a deuterium passivation process of optical fibers.

It is an object of this invention to reduce the time required to perform a deuterium passivation of optical fibers or preforms.

Another object of this invention is to provide a deuterium passivation process for optical fibers or preforms using a deuterium plasma.

It is yet a further object of the invention to provide a method for passivating a fiber, a preform, a fiber preform cane, or hollow preform in a high temperature (above 200° C.) deuterium gas.

### SUMMARY OF THE INVENTION

In accordance with the invention there is provided, a method of reducing a hydrogen content of an optical fiber or preform, which comprises applying a deuterium plasma to the optical fiber or preform for exchanging at least a portion of the hydrogen contained within the optical fiber or preform with deuterium.

In accordance with another embodiment of the present invention, the optical fiber or preform is placed in a cavity, a deuterium gas is provided to the cavity, and a deuterium plasma is generated from the deuterium gas prior to the step of applying the deuterium plasma.

In accordance with a further embodiment of the present invention, the method comprises the step of heating the optical fiber or preform in the deuterium plasma. In the case an optical fiber is passivated, the optical fiber is heated to a temperature of up to 200° C. as limited by the polymer coating of the fiber. In the case a preform is passivated, the preform is heated to a temperature of up to an annealing point of a core material of the preform.

In another embodiment of the invention, the method further comprises the step of reducing an amount of oxygen in the cavity prior to providing the deuterium gas. The step of reducing the oxygen is performed for reducing a number of defect sites in a core glass material of the optical fiber or preform. It comprises the steps of evacuating the cavity, providing an inert gas to the cavity, and removing (evacuating) said inert gas from the cavity. The inert gas is selected from the group consisting of helium, neon, argon, or other suitable inert gases.

In accordance with yet a further embodiment of the invention, the preform is a tube having a bore therethrough, and wherein said deuterium plasma is being applied to the bore.

The method of the present invention provides an optical fiber or preform having a reduced hydrogen content.

In accordance with the invention, there is further provided, a method of making an optical fiber or preform for reducing hydrogen induced losses of said optical fiber or preform comprising the following steps: a) placing the optical fiber or preform in a cavity, b) providing a deuterium gas to the cavity, c) forming a deuterium pleas from the deuterium gas, and d) allowing the optical fiber or preform to remain in the deuterium plasma for exchanging at least a portion of hydroxyls with deuteroxyls.

In accordance with another aspect of the invention, there is provided, a method of at least partially protecting an optical fiber from an attenuation increase due to hydrogen, said optical fiber being made from a preform tube having a bare therethrough, the method comprising the step of applying a deuterium plasma to the bore of the preform tube. A core glass material is deposited on an inner wall of the bore.

In accordance with a further embodiment, the method comprises the step of heating the preform tube while applying the deuterium plasma. Furthermore, the method comprises the steps of providing a deuterium gas to the bore; and generating a deuterium plasma from the deuterium gas in the bore prior to the step of applying the deuterium plasma.

Advantageously, the present invention provides a method of passivating an optical fiber or preform by reducing a hydrogen content in the fiber or preform. This reduces the required passivation time for optical fiber or performs over prior art methods. It is a further advantage that the present invention reduces the hydrogen aging of erbium-doped fibers using a deuterium ion plasma passivation process or a high temperature deuterium gas passivation of preforms.

### BRIEF DESCRIPTION OF THE DRAWINGS

Exemplary embodiments of the invention will now be described in conjunction with the following drawings wherein like numerals represent like elements, and wherein:

FIG. 1 shows prior art data that illustrate the large difference between conventional silica-based fiber and rare earth-doped fiber with regard to their susceptibility to hydrogen-induced loss increase;

FIG. 2 shows exemplary prior art data on hydrogen-induced loss increase as a function of wavelength;

FIG. 3 shows a schematic presentation of a deuterium ion D⁺ plasma passivation process of the present invention; and

FIG. 4 presents a schematic presentation of a deuterium ion D⁺ plasma passivation process of a preform sample before collapse.

### DETAILED DESCRIPTION OF THE PREFERRED EMBODIMENTS

Erbium-doped fibers were shown to have a sensitivity to hydrogen which is accelerated by both, temperature and partial pressure of hydrogen; M. J. LuValle et al., “Kinetic modeling of hydrogen induced degradation in erbium doped fiber amplifiers”, SPIE Vol. 3848, pp. 260-270, Part of the SPIE Conference on Optical Fiber Reliability and Testing, Boston, Mass., September 1999. As disclosed by Jin et al. in U.S. Pat. No. 5,274,734, silica-based optical fibers that are doped with Ge, Al and a rare earth (e.g., Er) can be susceptible to hydrogen-induced attenuation change. Jin et al. state that such fiber can exhibit loss increase rates that are, at 20° C., 10⁶ times larger than those of a standard single mode fiber. Further, they suggest that transition metal-doped silica-based fibers can exhibit large hydrogen-induced attenuation change. In many circumstances (e.g., amplifier fiber, attenuator fiber) a significant attenuation change of optical fiber is undesirable.

One elegant way of “passivating” the fiber against this effect is to expose the fiber to deuterium gas at the appropriate pressure and temperature, as was explained heretofore. Deuterium is chemically identical to hydrogen and will diffuse into the fiber and react with available sites to form OD groups just as hydrogen would form OH groups. The presence of the deuterium prevents further reaction with hydrogen when exposed to hydrogen in the field by reacting with all the available sites in the glass. When the fiber is exposed to hydrogen after passivation, the hydrogen will still diffuse into the core, but will not react since there are no available sites left. The reason why deuterium is used for passivation is that the optical loss caused by OH is shifted to lower wavelengths, out of the region of interest, when OD is formed. This is due to the fact that the mass of the deuterium atom is twice that of hydrogen and causes the fundamental OH stretch and its' harmonics to be shifted to longer wavelengths.

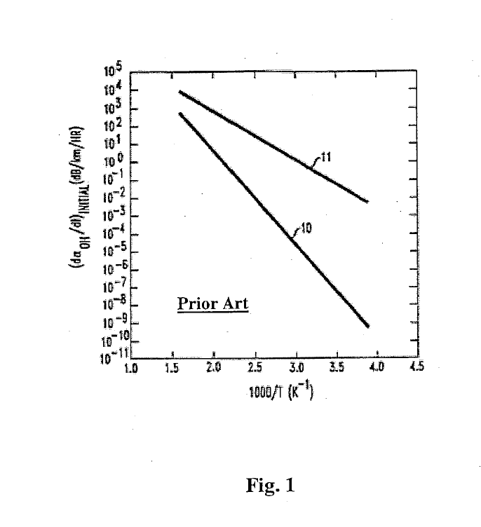

FIG. 1 shows prior art data of (dα_{OH}/dt)ᵢₙᵢₜᵢₐₗ (the initial rate of fiber loss increase due to OH in the fiber) vs. inverse absolute temperature as presented in U.S. Pat. No. 5,274,734 incorporated herein by reference. The initial rate is a known measure of the susceptibility of a fiber to hydrogen-induced loss. See, for instance, A. Tomita & P. J. Lemaire, “Hydrogen-Induced Loss Increases in Germanium-Doped Single-Mode Optical Fibers. Long-Term Predictions”, Electronics Letters, 17^{th} January 1985, Vol. 21, No. 2, pp. 71-72, incorporated herein by reference. The data were obtained by exposing conventional single mode transmission fibers (5 D fiber available from AT&T; curve 10) and single mode Er-doped amplifier fiber (core doping 18% GeO₂; 2% Al₂O₃ and 200 ppm Er; curve 11) to 1 atmosphere of H₂ a various temperatures, and measuring the rate of fiber loss increase at λ=1.4 μm. FIG. 1 shows that at 70° C., the initial rate of increase of the 5 D and Er-doped fibers is about 10⁻⁴ and 3 dB/km·hour, respectively, and at 7° C., it is about 3×10⁻⁴ and 6×10⁻² dB/km·hour, respectively. FIG. 1 thus clearly demonstrates the huge difference in the susceptibility to hydrogen-induced loss between Ge-doped conventional transmission fiber and Er-doped amplifier fibers especially at expected operating temperatures (e.g., 3°-70° C.).

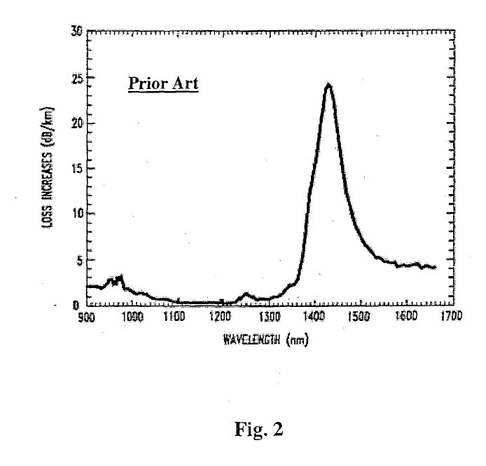

FIG. 2 shows a hydrogen-induced loss increase in an Er-doped silica-based fiber after 24 hours at 213° C. in 10⁻⁴ atmospheres of H₂, as disclosed in U.S. Pat. No. 5,274,734. The fiber did not have its hydroxyl sites (OH) exchanged with deuteroxyl sites (OD), and hence quickly depleted by reaction with hydrogen. The main loss peak at about 1.43 μm is believed to be due to the formation of OH in the fiber core. It is to be noted that this peak causes significant loss increase at 1.48 μm (a possible pump wavelength for Er-doped fiber amplifiers) and at 1.55 μm (a likely signal wavelength).

The present invention provides a method of reducing a hydrogen content of an optical fiber or preform. The method in accordance with the present invention reduces the required time for passivating optical fibers, preforms, or canes in comparison to prior art methods. A cane is a preform drawn to a rod having a smaller diameter than the initial preform. The smaller diameter of a cane reduces a deuterium diffusion time and hence by using a preform cane, the passivation time can be further reduced. The term preform as used herein is intended to include both, a preform and a cane.

In accordance with an embodiment of the present invention a deuterium ion passivation is performed as stimulated by a plasma. Therefore, a deuterium plasma is applied to an optical fiber or preform to exchange hydrogen contained therein with deuterium. At room temperature, deuterium is in a gaseous state of the molecular form D₂. Deuterium ion D⁺ is more chemically active than molecular deuterium D₂, and hence it can accelerate the chemical reaction of exchanging hydroxyls for deuteroxyls OH⇄OD in optical fibers or preforms resulting in a decrease in time for passivation. Furthermore, the time period for the treatment is relative to both temperature and pressure and shall continue for a time which is sufficiently long to enable the deuterium to permeate the fiber or preform.

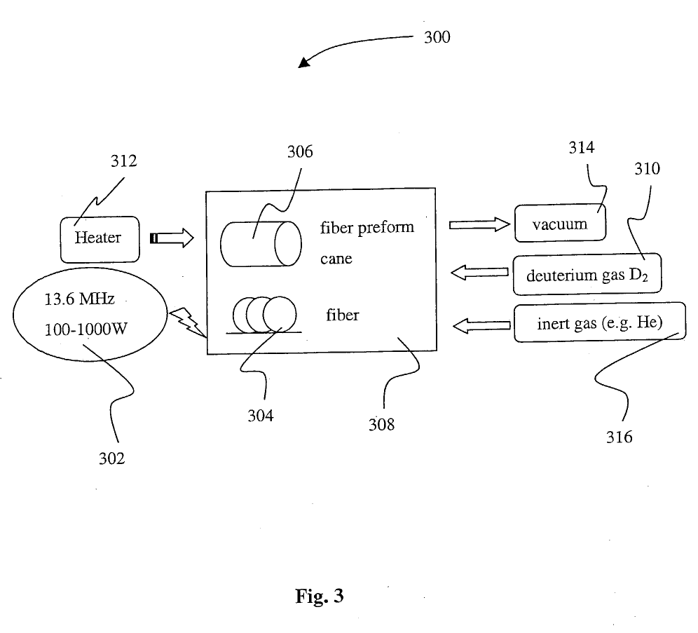

Turning now to FIG. 3 a schematic presentation 300 of a deuterium ion D⁺ plasma passivation process of the present invention is shown. The deuterium ion D⁺ can be stably formed in a deuterium plasma which can be caused by a high frequency electric field 302 (13.6 MHz; 100-1000W) as shown in FIG. 3. The optical fiber 304 or preform 306 to be passivated are placed in a cavity 308. Then, a deuterium gas is applied to the cavity via deuterium line 310 and a deuterium plasma is generated from the deuterium gas. Usually, cavity 308 is evacuated before the deuterium gas is applied. The deuterium gas is injected into cavity 308 to keep a chamber pressure of several tens of Torr, for example. The optical fiber 304 or preform 306 are allowed to remain in the cavity sufficiently long to replace a desired amount of hydrogen with deuterium.

In accordance with another embodiment of the invention, the optical fiber 304 or preform 306 are heated with a beater 312 in the deuterium plasma in cavity 308 to further reduce the passivation time. Cavity 308 can be heated up to several hundred degrees centigrade which is variably dependent upon the thermal resistance of the samples (optical fiber or preform). The optical fiber can usually be heated to a temperature of to 200° C. which is limited by the polymer coating of the optical fiber. The preform 306 can be heated to a temperature of up to annealing point of a core material of the preform 306.

The cavity 308 is a passivation chamber made from glass or stainless steel. In accordance with yet another embodiment of the instant invention, an amount of oxygen within cavity 308 is reduced to reduce defect sites in the fiber core glass caused by oxygen ions. Thus, in order to reduce the oxygen trace in cavity 308, cavity 308 is evacuated through vacuum line 314, for example to a pressure of approximately 10 Torr, then an inert as, such as helium, neon, or argon, is provided to the cavity 308 through an inert gas line 316, and then removed again via vacuum line 314. This procedure of evacuating the cavity 308, of providing an inert gas to the cavity 308, and then evacuating the inert gas again is repeated several times so that the amount of oxygen in cavity 308 is eliminated or reduced to a desired level. If it is desired to reduce the amount of oxygen in cavity 308, this procedure is performed prior to applying the deuterium gas to the cavity.

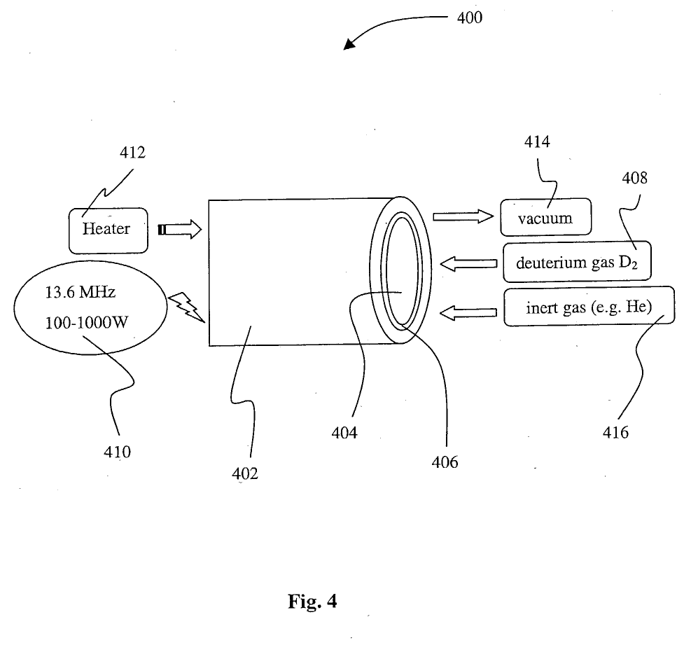

In accordance with a further embodiment of the present invention 400, the inventive passivation process can also be accepted as an on-line or off-line passivation process in the preform sample before collapse. This is shown in more detail in conjunction with FIG. 4 presenting a schematic presentation of a deuterium ion D⁺ plasma passivation process of a preform sample before collapse. A preform 402 off a tubular shape having a bore therethrough, presents a cavity 404 for applying a deuterium plasma therein, and the core glass material 406 deposited on an inner surface/wall of the tube can be passivated. In order to perform the passivation process in cavity 404, a deuterium gas is applied directly to the bore via a deuterium line 408. A high frequency electric field 410 is applied to generate the deuterium plasma from the deuterium gas. If desired, the preform is heated with a heater 412 to a temperature of up to an annealing point of a core glass material 406 of the preform 402 to further reduce the passivation time. As was explained heretofore in conjunction with FIG. 3, an amount of oxygen can be removed from cavity 404 to reduce a number of defect sites caused by the oxygen, by evacuating the bore or cavity 404 via vacuum line 414, providing an inert gas to cavity 404 via an inert gas line 416, and then evacuating the inert gas again from the cavity 404 via vacuum line 414. This step is repeated several times until enough oxygen is removed from cavity 404. After the hollow, tubular preform is passivated, it is collapsed into a rod.

In accordance with yet a further embodiment of the present invention, a passivation process is performed wherein a fiber preform cane or hollow preform is passivated in a high temperature deuterium gas.

The diffusion process is quite well characterized by the diffusion equation with a diffusity given by

D=D₀e^{-E/RT}

wherein D₀ is a constant independent of ambient gas pressure and temperature, E is the activity energy for the diffusion process, R is the gas constant, and T is the absolute temperature.

The value for hydrogen is; D_{H}_{₁}=5.65×10⁻⁴e^{-(10.4} kcal/mole)/RTcm²·s⁻¹

The value for deuterium is; D_{D}_{₂}=5.0×10⁻⁴e^{-(10.5 kcal/mole)/RT}cm²·s⁻¹

According to the diffusion constant, molecular deuterium can diffuse a 1 mm thick silica fiber glass at approximately 560° C., 1 atm D₂ in less than 1 hour. Usually, the thickness of a fiber core film before a preform is collapsed, is around 3 mm, so a passivation time can be as short as several hours. This high temperature passivation process can be operated in an on-line Modified Chemical Vapor Deposition (MCVD) preform process at a high temperature by the hydrogen-oxygen burner, or an off-line process wherein a hollow preform is placed in a high temperature furnace. Aside from the off-line passivation process, it is also good to passivate a rod-shaped preform cane with a diameter of up to approximately 10 mm. For example, a 10 mm thick rod can be passivated in less than 10 hours at 800-900° C. If desired, high pressure is used to further shorten the passivation time. Pressures of up to several hundreds atm are acceptable in the off-line passivation process.

The above described embodiments of the invention are intended to be examples of the present invention and numerous modifications, variations, and adaptations may be made to the particular embodiments of the invention without departing from the spirit and scope of the invention, which is defined in the claims.

What is claimed is:

1. A method of reducing a hydrogen content of an optical fiber or preform, which comprises applying a deuterium plasma to the optical fiber or preform for exchanging at least a portion of the hydrogen contained within the optical fiber or preform with deuterium.

2. The method as defined in claim 1 further comprising the steps of placing the optical fiber or preform in a cavity; providing a deuterium gas to the cavity; and generating a deuterium plasma from the deuterium gas prior to the step of applying the deuterium plasma.

3. The method as defined in claim 2 further comprising the step of heating the optical fiber or preform in the deuterium plasma.

4. The method as defined in claim 3 wherein the optical fiber is heated to a temperature of up to 200° C.

5. The method as defined in claim 3 wherein the preform is heated to a temperature of up to an annealing point of a core material of the preform.

6. The method as defined in claim 2 further comprising the step of reducing an amount of oxygen in the cavity prior to providing the deuterium gas.

7. The method as defined in claim 6 wherein the step of reducing the amount of oxygen comprises the steps of evacuating the cavity, providing an inert gas to the cavity, and removing said inert gas from the cavity.

8. The method as defined in claim 7 wherein the inert gas is selected from the group consisting of helium, neon, and argon.

9. The method as defined in claim 1 wherein the preform is a tube having a bore therethrough, and wherein said deuterium plasma is being applied to the bore.

10. An optical fiber or preform having a reduced hydrogen content made by the method as defined in claim 1.

11. A method of making an optical fiber or preform for reducing hydrogen induced losses of said optical fiber or preform comprising at following steps:
a) placing the optical fiber or preform in a cavity;
b) providing a deuterium gas to the cavity;
c) forming a deuterium plasma from the deuterium gas; and
d) allowing the optical fiber or preform to remain in the deuterium plasma for exchanging at least a portion of hydroxyls with deuteroxyls.

12. The method as defined in claim 11 further comprising the step of heating the optical fiber or preform while said optical fiber or preform remains in the deuterium plasma.

13. The method as defined in claim 12 wherein the optical fiber is heated to a temperature of up to 200° C.

14. The method as defined in claim 12 wherein the preform is heated to a temperature of up to an annealing point of a core glass material of the preform.

15. The method as defined in claim 11 further comprising the step of reducing an amount of oxygen in the cavity prior to performing step b) for reducing a number of defect sites in a core glass material of the optical fiber or preform.

16. The method as defined in claim 15 wherein the step of reducing the amount of oxygen in the cavity includes the steps of:
evacuating the cavity;
providing an inert gas to the cavity; and
evacuating said inert gas from the cavity.

17. A method for at least partially protecting an optical fiber from an attenuation increase due to hydrogen, said optical fiber being made from a preform tube having a bore therethrough, the method comprising the step of applying a deuterium plasma to the bore of the preform tube.

18. The method as defined in claim 17 wherein a core glass material is deposited on an inner wall of the bore.

19. The method as defined in claim 18 further comprising the step of heating the preform tube while applying the deuterium plasma.

20. The method as defined in claim 18 further comprising the steps of providing a deuterium gas to the bore; and generating a deuterium plasma from the deuterium gas in the bore prior to the step of applying the deuterium plasma.
